(19) United States
(12) Patent Application Publication
(10) Pub. No.: US 2017/0279898 A1
(43) Pub. Date: Sep. 28, 2017

(54) Method for Accessing Virtual Desktop and Mobile Terminal

(71) Applicant: Beijing Xiaomi Mobile Software Co., Ltd., Haidian District, Beijing (CN)

(72) Inventors: Dongdong YANG, Beijing (CN); Guosheng LI, Beijing (CN); Chao FENG, Beijing (CN)

(73) Assignee: Beijing Xiaomi Mobile Software Co., Ltd., Haidian District, Beijing (CN)

(21) Appl. No.: 15/435,773

(22) Filed: Feb. 17, 2017

(30) Foreign Application Priority Data
Mar. 23, 2016 (CN) 201610169909.9

(51) Int. Cl. H04L 29/08

(52) U.S. Cl. CPC H04L 67/141; H04L 67/16

(57) ABSTRACT

The present disclosure provides a method for accessing a virtual desktop and a mobile terminal. The method for accessing the virtual desktop includes: obtaining preset address information by a mobile terminal, in which the address information includes a communication address of a virtual desktop client; and establishing a connection between the virtual desktop client and the mobile terminal according to the communication address of the virtual desktop client, and receiving virtual desktop information sent by the virtual desktop client.

### CROSS-REFERENCE TO RELATED APPLICATION

This application is based on and claims priority to Chinese Patent Application Serial No. CN 201610169909.9, filed with the State Intellectual Property Office of P. R. China on Mar. 23, 2016, the entire content of which is incorporated herein by reference.

### TECHNICAL FIELD

The present disclosure relates to communication field, and more particularly to a method for accessing a virtual desktop and a mobile terminal.

### BACKGROUND

In daily life, attending a meeting or training is common. However, generally, there may be a lot of people in a large conference room or a lecture hall during the meeting or training, such that the people sitting in the back, especially those people with poor eyesight, may not watch speech content presented and/or a PowerPoint slide of the meeting or training clearly.

### SUMMARY

The present disclosure provides a method for accessing a virtual desktop and a mobile terminal.

According to embodiments of a first aspect of the present disclosure, a method for accessing a virtual desktop is provided. The method may include: obtaining preset address information by a mobile terminal, in which the address information includes a communication address of a virtual desktop client; and establishing a connection between the virtual desktop client and the mobile terminal according to the communication address of the virtual desktop client, and receiving virtual desktop information sent by the virtual desktop client.

According to embodiments of a second aspect of the present disclosure, a mobile terminal is provided. The mobile terminal may include: a processor; a receiver, configured to obtain preset address information, in which the address information includes a communication address of a virtual desktop client; and a memory, configured to store instructions executable by the processor, in which the processor is configured to: establish a connection between the virtual desktop client and the mobile terminal according to the communication address of the virtual desktop client, and receive virtual desktop information sent by the virtual desktop client.

According to embodiments of a third aspect of the present disclosure, a non-transitory computer readable storage medium is provided. The storage medium has stored therein instructions that, when executed by one or more processors of a mobile terminal, cause the mobile terminal to perform: obtaining preset address information by a mobile terminal, wherein the address information comprises a communication address of a virtual desktop client; and establishing a connection between the virtual desktop client and the mobile terminal according to the communication address of the virtual desktop client, and receiving virtual desktop information sent by the virtual desktop client.

It should be understood that, the above general description and following detail description are exemplary and explanatory, and shall not be construed to limit the present disclosure.

### BRIEF DESCRIPTION OF THE DRAWINGS

These and other aspects and advantages of embodiments of the present disclosure will become apparent and more readily appreciated from the following descriptions made with reference to the drawings.

FIG. 1 is a flow chart of a method for accessing a virtual desktop according to an example embodiment of the present disclosure.

FIG. 2 is a schematic diagram of a method for accessing a virtual desktop according to another example embodiment of the present disclosure.

FIG. 3 is a block diagram of a mobile terminal according to an example embodiment of the present disclosure.

FIG. 4 is a block diagram of a mobile terminal according to another example embodiment of the present disclosure.

FIG. 5 is a block diagram of a device for accessing a virtual desktop according to an example embodiment of the present disclosure.

Skilled artisans will appreciate that elements in the figures are illustrated for simplicity and clarity and have not necessarily been drawn to scale. For example, the dimensions and/or relative positioning of some of the elements in the figures may be exaggerated relative to other elements to help to improve understanding of various examples of the present disclosure. Also, common but well-understood elements that are useful or necessary in a commercially feasible example are often not depicted in order to facilitate a less obstructed view of these various examples. It will further be appreciated that certain actions and/or steps may be described or depicted in a particular order of occurrence while those skilled in the art will understand that such specificity with respect to sequence is not actually required. It will also be understood that the terms and expressions used herein have the ordinary technical meaning as is accorded to such terms and expressions by persons skilled in the technical field as set forth above, except where different specific meanings have otherwise been set forth herein.

### DETAILED DESCRIPTION

Example embodiments will be described in detail herein, and examples thereof are illustrated in accompanying drawings. Throughout figures referred by the following description, the same reference number in different figures indicates the same or similar elements unless otherwise stated. Implementation methods described in the following exemplary embodiments do not represent all the implementation methods consistent with the present disclosure. Instead, they are only examples of the device and method consistent with some aspects of the present disclosure detailed in the appended claims.

The terminology used in the present disclosure is for the purpose of describing exemplary examples only and is not intended to limit the present disclosure. As used in the present disclosure and the appended claims, the singular forms “a,” “an” and “the” are intended to include the plural forms as well, unless the context clearly indicates otherwise. It shall also be understood that the terms “or” and “and/or” used herein are intended to signify and include any or all possible combinations of one or more of the associated listed items, unless the context clearly indicates otherwise.

It shall be understood that, although the terms “first,” “second,” “third,” etc. may be used herein to describe various information, the information should not be limited by these terms. These terms are only used to distinguish one category of information from another. For example, without departing from the scope of the present disclosure, first information may include termed as second information; and similarly, second information may also be termed as first information. As used herein, the term “if” may include understood to mean “when” or “upon” or “in response to” depending on the context.

Reference throughout this specification to “one embodiment,” “an embodiment,” “exemplary embodiment,” or the like in the singular or plural means that one or more particular features, structures, or characteristics described in connection with an example is included in at least one embodiment of the present disclosure. Thus, the appearances of the phrases “in one embodiment” or “in an embodiment,” “in an exemplary embodiment,” or the like in the singular or plural in various places throughout this specification are not necessarily all referring to the same embodiment. Furthermore, the particular features, structures, or characteristics in one or more embodiments may include combined in any suitable manner.

Some terms that may be related to the embodiments of the present disclosure are:

Near Field Communication (NFC): short-distance and high-frequency radio technology, when operating at a frequency of 13.56 MHz within a distance of 20 cm, the NFC communication may enable a terminal like a personal computer and a hand-held device (e.g. a PAD, a cellphone) to perform recognizing and data exchanging in a short distance.

Media Access Control (MAC) address: referred to as physical address, configured to show an identifier of each site on the internet, the MAC address is a fixed address determined by a network card, and each terminal device has a corresponding MAC address.

Internet Protocol (IP) address: a uniform address format provided by the IP, a logic address distributed to each network on the internet and each terminal device for shielding differences of the MAC addresses, and each network has a corresponding IP address.

Wireless Fidelity (WIFI): a high-frequency radio signal, a technology that may interconnect terminals like a personal computer, a hand-held device (e.g. a PAD or a cellphone) with each other in a wireless manner.

Bluetooth: a wireless technology standard, which may realize data exchange between terminals like a personal computer and a hand-held device (e.g. a PAD or a cellphone) in a short distance.

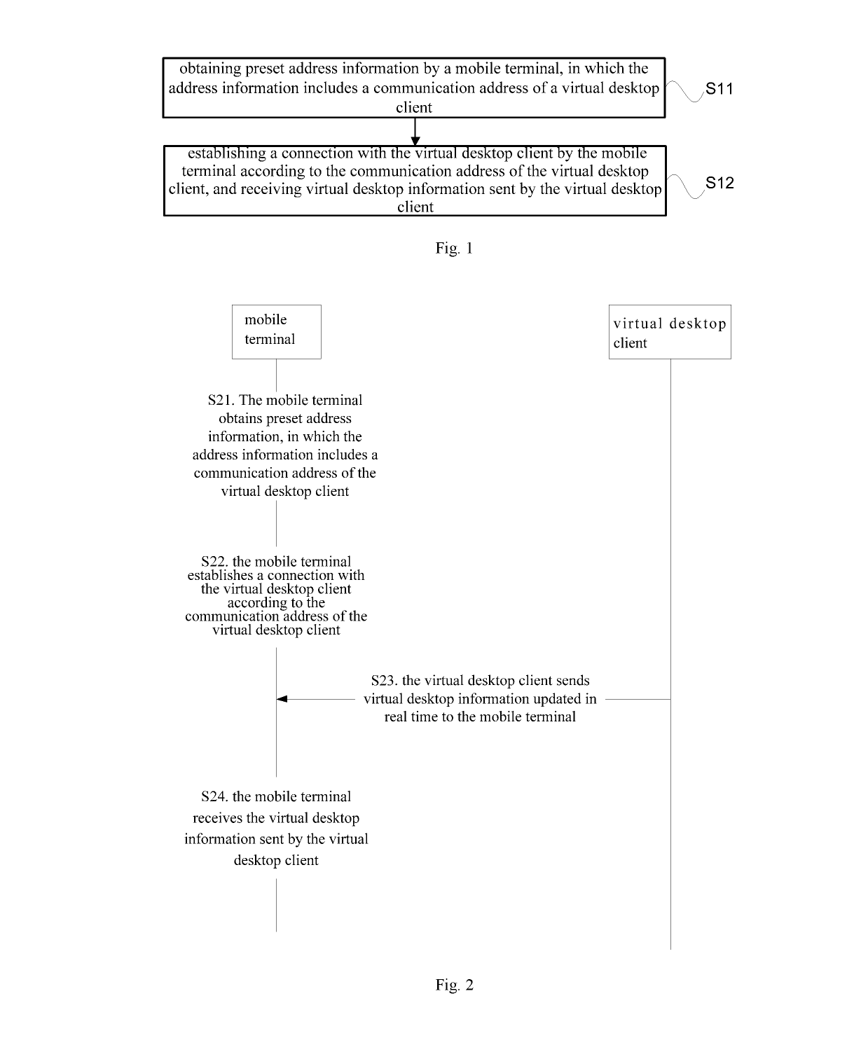

FIG. 1 is a flow chart of a method for accessing a virtual desktop according to an example embodiment of the present disclosure. As shown in FIG. 1, the method for accessing a virtual desktop in this embodiment may be applied in a mobile terminal. The terminal may be a cellphone, a tablet computer, a laptop and wearable device supporting NFC. The method for accessing the virtual desktop may include steps as follows.

In step S11, the mobile terminal obtains preset address information, in which the address information includes a communication address of a virtual desktop client.

In embodiments of the present disclosure, when attending a meeting at a conference room or attending a training, each participant obtain the preset address information through a mobile terminal with a NFC function when entering the conference room, in which, the preset address information is a communication address of a the virtual desktop client preset by a sponsor. The address may be a MAC address or an IP address.

It should be noted that, the preset address information is set on a fixed device by the sponsor of the conference in advance, and the preset address information may be obtained by the mobile terminal through contacting or scanning the fixed device.

In step S12, the mobile terminal establishes a connection with the virtual desktop client according to the communication address of the virtual desktop client, and receives virtual desktop information sent by the virtual desktop client.

In the embodiments of the present disclosure, according to the obtained communication address of the virtual desktop client, the mobile terminal may determine the virtual desktop client needs to be accessed, that is, the mobile terminal may determine which virtual desktop client to be connected with according to the obtained communication address of the virtual desktop client, the mobile terminal may obtain the connection with the virtual desktop client via wireless network like the Bluetooth and WIFI, and the mobile terminal may receive the virtual desktop information updated in real time and sent by the virtual desktop client, such that a remote access to the virtual desktop via the mobile terminal is realized, and the participants may watch speech content presented and/or a PowerPoint slide of the meeting or the training synchronously via the mobile terminal.

It should be noted that, the specific implementation process and principle of establishing a connection with the virtual desktop client by the mobile terminal according to the communication address of the virtual desktop client is similar to the specific implementation process and principle of establishing a connection between two terminal devices according to the communication address, which may not be limited and elaborated herein.

It should be noted that, in the embodiments of the present disclosure, not only the preset address information is set on the fixed device by the sponsor in advance or during the conference, but other communication information like communication connection information which may realize establishing a connection between the mobile terminal and the virtual desktop client may also be set on the fixed device in advance or during the conference, i.e., the mobile terminal may establish a connection between the mobile terminal and the virtual desktop client by contacting or scanning the communication connection information on the fixed device.

It should be noted that, if any one of the mobile terminal and the virtual desktop client breaks connection, the transmission of virtual desktop information between the mobile terminal and the virtual desktop client terminates. For example, if a mobile terminal of a person attending the meeting disconnects from the virtual desktop client, the mobile terminals of other people may still receive the virtual desktop information sent by the virtual desktop client; and if the virtual desktop client breaks connection, the mobile terminals of all the people disconnect from the virtual desktop client, and may not receive the virtual desktop information sent by the virtual desktop client.

According to the method for accessing the virtual desktop in embodiments of the present disclosure, the mobile terminal obtains the preset address information, establishes a connection with the virtual desktop client according to the communication address of the virtual desktop client and receives virtual desktop information sent by the virtual desktop client, such that people attending a meeting may establish a connection with the virtual desktop client via the mobile terminals carried by themselves. As such, the method may realize the quick verification and the establishment of the access by using the virtual desktop. With remote access to the virtual desktop via the mobile terminal, people attending the meeting can watch speech content presented and/or a PowerPoint slide of a meeting or a training synchronously via the mobile terminal, which avoids a problem that the people with poor eyesight cannot watch the speech content presented and/or the PowerPoint side of the meeting or the training clearly, thus improving usability of accessing the virtual desktop and improving the user experience for the mobile terminal.

Further, in the above embodiments, the mobile terminal may obtain the preset address information in following ways.

In a first way, the mobile terminal obtains the preset address information stored in a NFC reader by performing NFC communication with the NFC reader.

In the embodiments of the present disclosure, the sponsor of the conference may store the preset address information in the NFC reader in advance, in which the NFC reader may be a reader supporting the NFC, such as a NFC chip card and a reader terminal supporting the NFC, or may be any other means. The mobile terminal performs the NFC communication with the NFC reader. For example, when the NFC reader is a NFC chip card, the conference participant contacts his mobile terminal supporting the NFC to the NFC chip card when entering the conference room, i.e. swipes the chip card when entering the conference room, such that the mobile terminal performs the NFC communication with the NFC reader, and thus obtains the address information preset in the NFC chip card. When the NFC reader is a reader terminal supporting the NFC, the participant contacts his mobile terminal supporting the NFC to the reader terminal supporting the NFC when entering the conference room, such that a point-to-point data transmission between the mobile terminal supporting the NFC and the reader terminal supporting the NFC is conducted, and the NFC communication between the mobile terminal and the NFC reader is performed, and thus the address information preset in the reader terminal supporting the NFC is obtained.

In a second way, the mobile terminal obtains preset address information in a barcode or a two-dimensional code by scanning the barcode or the two-dimensional code.

In the embodiments of the present disclosure, the sponsor may set the preset address information in a barcode or a two-dimensional code in advance, and the participant scans the barcode or the two-dimensional code via the mobile terminal supporting the NFC he or she carries when entering the conference room, and thus the address information preset in the NFC chip card may be obtained.

Further, in the above embodiments, the communication address of the virtual desktop client may be a MAC address of the virtual desktop client, and establishing a connection with the virtual desktop client by the mobile terminal according to the communication address of the virtual desktop client includes:

establishing a connection with the virtual desktop client by the mobile terminal according to the MAC address of the virtual desktop client.

In the embodiments of the present disclosure, since each virtual desktop client has one MAC address and the MAC address is pre-burned by a manufacturer which is generally cannot be changed. Therefore, in the embodiments of the present disclosure, the MAC address of the virtual desktop client is used as the communication address of the virtual desktop client, and the MAC address of the virtual desktop client is preset in the NFC reader, the barcode or the two-dimensional code by the sponsor, such that the mobile terminal obtains the preset MAC address from the NFC reader, the barcode or the two-dimensional code, and can determine to access which virtual desktop client according to the obtained MAC address.

According to the method for accessing the virtual desktop in embodiments of the present disclosure, the mobile terminal obtains the preset address information, establishes a connection with the virtual desktop client according to the communication address of the virtual desktop client and receives virtual desktop information sent by the virtual desktop client, such that people attending a meeting may establish a connection with the virtual desktop client via the mobile terminals carried by themselves, and the quick verification and establishment of accessing the virtual desktop may be realized. With remote access to the virtual desktop via the mobile terminal, people attending the meeting can watch speech content presented and/or a PowerPoint slide of a meeting or a training synchronously via the mobile terminal, which avoids a problem that the people with poor eyesight cannot watch the speech content presented and/or the PowerPoint slide of the meeting or the training clearly, thus improving usability of accessing the virtual desktop and improving user experience. In addition, the mobile terminal obtains the preset address information in various ways such as by performing NFC communication with the NFC reader, by scanning the barcode or the two-dimensional code, such that a quick verification and establishment of accessing the virtual desktop may be realized, and thus the usability of accessing the virtual desktop is improved.

Further, in the above embodiments, establishing a connection with the virtual desktop client by the mobile terminal according to the MAC address of the virtual desktop client may include:

establishing a connection with the virtual desktop client by the mobile terminal via a wireless network according to the MAC address of the virtual desktop client.

In detail, the wireless network is a Bluetooth or a WIFI.

In the embodiments of the present disclosure, the mobile terminal can determine which virtual desktop client to be connected with according to the obtained MAC address of the virtual desktop client, and the mobile terminal can obtain the connection to the MAC address of the virtual desktop client via the wireless network like Bluetooth and WIFI, such that a connection with the virtual desktop client is established.

For example, multiple virtual desktop clients may exist in a meeting or training. However, in an embodiment of the present disclosure, an example in which there are two virtual desktop clients is described mainly, which shall not be construed to limit the present disclosure. For example, virtual desktop information in the virtual desktop client A is used for being watched and used by staff of the sponsor, and virtual desktop information in the virtual desktop client B is used for being watched and used by people attending the meeting. Since each virtual desktop client will has one unique MAC address, and the MAC address of the virtual desktop client A is different from the MAC address of the virtual desktop client B, the mobile terminal of the person attending the meeting can determine to connect with the virtual desktop B when obtaining the preset MAC address of the virtual desktop client B, such that a remote access to the virtual desktop is realized via the mobile terminal, and the people attending the meeting may watch speech content presented and/or a PowerPoint slide of the meeting or the training synchronously via the mobile terminal.

It should be noted that, in the embodiments of the present disclosure, the specific implementation principle and process of obtaining the connection to the MAC address of the virtual desktop client by the mobile terminal via the wireless network like Bluetooth or WIFI may be similar to the specific implementation principle and process of obtaining the connection to the MAC address by the mobile terminal via the wireless network like Bluetooth or WIFI in other applications and fields.

According to the method for accessing the virtual desktop in embodiments of the present disclosure, the mobile terminal obtains the preset address information, establishes a connection with the virtual desktop client according to the communication address of the virtual desktop client and receives virtual desktop information sent by the virtual desktop client, such that people attending a meeting may establish a connection with the virtual desktop client via the mobile terminals carried by themselves, and a quick verification and establishment of accessing the virtual desktop may be achieved. With remote access to the virtual desktop via the mobile terminal, people attending the meeting can watch speech content presented and/or a PowerPoint slide of a meeting or a training synchronously via the mobile terminal, which avoids a problem that the people with poor eyesight cannot watch the speech content presented and/or the PowerPoint slide of the meeting or the training clearly, thus improving usability of accessing the virtual desktop and improving user experience. In addition, the mobile terminal obtains the preset address information in various ways such as by performing NFC communication with the NFC reader, by scanning the barcode or the two-dimensional code, such that a quick verification and establishment of accessing the virtual desktop may be achieved, and thus the usability of accessing the virtual desktop is improved. In addition, the mobile terminal establishes the connection with the virtual desktop client via the wireless network according to the MAC address of the virtual desktop client, in which the wireless network is Bluetooth or WIFI, such that a quick verification and establishment of connection of the mobile terminal and the virtual desktop client may be achieved, and the usability of accessing the virtual desktop is improved.

FIG. 2 is a schematic diagram of a method for accessing a virtual desktop according to another example embodiment of the present disclosure. In the present embodiment, the technical solution of the present disclosure is described by taking the mobile terminal and the virtual desktop client performing information interaction as an example. As shown in FIG. 2, the method for accessing a virtual desktop may include steps as follows.

In step S21, a mobile terminal obtains preset address information, in which the address information may include a communication address of a virtual desktop client.

It should be noted that, the implementation of step S21 is the same with S11, and reference may be made to step S11, which may not be elaborated herein.

In step S22, the mobile terminal establishes a connection with the virtual desktop client according to the communication address of the virtual desktop client.

It should be noted that, the implementation of step S22 is the same with S12, and reference may be made to step S12, which may not be elaborated herein.

In step S23, the virtual desktop client sends virtual desktop information updated in real time to the mobile terminal.

In the embodiments of the present disclosure, after the mobile terminal establishes the connection with the virtual desktop client, a NFC monitoring program is started by the virtual desktop client, a NFC communication is established between the virtual desktop client and the mobile terminal, and the virtual desktop information updated in real time is sent to the mobile terminal, e.g. an operation status of the virtual desktop and session information in the virtual desktop client are sent to the mobile terminal, in which, the session information of the virtual desktop may be speech content presented and/or a PowerPoint slide of a meeting or a training.

The establishment of the connection may be conducted before or in the middle of a meeting or a training. For example, before the meeting starts, the participants of the meeting may establish the connection with the virtual desktop client by using their mobile devices. Alternatively, the connection may be establish during the meeting. For example, when a participant finds out that it is not easy for him or her to see the meeting presentation such as a PowerPoint slide, the participant may choose to establish the connection with the virtual desktop client.

In step S24, the mobile terminal receives virtual desktop information sent by the virtual desktop client.

In the embodiments of the present disclosure, after the mobile terminal establishes the connection with the virtual desktop client, a NFC monitoring program is started by the mobile terminal, a NFC communication is established between the virtual desktop client and the mobile terminal, and the virtual desktop information updated in real time and sent by the virtual desktop client is received by the mobile terminal, e.g. an operation status of the virtual desktop and session information in the virtual desktop client are received by the mobile terminal, in which, the session information of the virtual desktop may be speech content presented and/or a PowerPoint slide of a meeting or a training. Thus, a remote access to the virtual desktop via the mobile terminal is achieved, and the participant may watch the speech content presented and/or the PowerPoint slide of the meeting or the training synchronously via the mobile terminal.

According to the method for accessing the virtual desktop in embodiments of the present disclosure, the mobile terminal obtains the preset address information, establishes a connection with the virtual desktop client according to the communication address of the virtual desktop client and receives virtual desktop information sent by the virtual desktop client, such that people attending a meeting may establish a connection with the virtual desktop client via the mobile terminals carried by themselves, such that a quick verification and establishment of accessing the virtual desktop may be achieved. With remote access to the virtual desktop via the mobile terminal, people attending the meeting can watch speech content presented and/or a PowerPoint slide of a meeting or a training synchronously via the mobile terminal, which avoids a problem that the people with poor eyesight cannot watch the speech content presented and/or the PowerPoint slide of the meeting or the training clearly, thus improving usability of accessing the virtual desktop and improving user experience.

It may be noted that the virtual desktop may send additional information to the mobile terminal other than the presentation materials. For example, the virtual desktop may send the presenter's or trainer's biography to be displayed in the mobile terminal. Also, the virtual desktop may send the background information for the presentation materials such as technical background for the presented topic to the mobile terminal. Furthermore, the virtual desktop may send the future meeting reminder or the conference schedule to the mobile terminal.

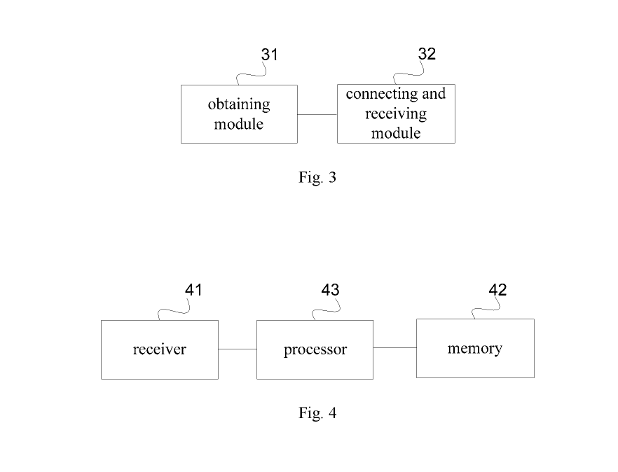

FIG. 3 is a block diagram of a mobile terminal according to an example embodiment of the present disclosure. Referring to FIG. 3, the mobile terminal may include: an obtaining module 31 and a connecting and receiving module 32.

The obtaining module 31 is configured to obtain preset address information, in which the address information may include a communication address of a virtual desktop client.

The connecting and receiving module 32 is configured to establish a connection with the virtual desktop client according to the communication address of the virtual desktop client, and to receive virtual desktop information sent by the virtual desktop client.

Further, the obtaining module 31 includes a first obtaining sub-module.

The first obtaining sub-module is configured to obtain the preset address information stored in a NFC reader by performing NFC communication with the NFC reader.

Further, the obtaining module 31 includes a second obtaining sub-module.

The second obtaining sub-module is configured to obtain the preset address information in a barcode or a two-dimensional code by scanning the barcode or the two-dimensional code.

Further, the communication address of the virtual desktop client obtained by the obtaining module 31 is a MAC address of the virtual desktop client; and the connecting and receiving module 32 may include a connecting sub-module.

The connecting sub-module is configured to establish a connection with the virtual desktop client according to the MAC address of the virtual desktop client.

Further, the connecting sub-module may include a wireless connection sub-module.

The wireless connection sub-module is configured to establish a connection with the virtual desktop client via a wireless network according to the MAC address of the virtual desktop client.

The wireless network connected by the wireless connection sub-module may be a Bluetooth or a WIFI.

With respect to the devices in the above embodiments, the specific operation modes of individual modules therein have been described in detail in the embodiments regarding the methods, which will not be elaborated herein.

According to the mobile terminal in the embodiments of the preset disclosure, by obtaining the preset address information, establishing a connection with the virtual desktop client according to the communication address of the virtual desktop client and receiving virtual desktop information sent by the virtual desktop client, people attending a meeting may establish a connection with the virtual desktop client via the mobile terminals carried by themselves, such that a quick verification and establishment of accessing the virtual desktop may be realized. With remote access to the virtual desktop via the mobile terminal, people attending the meeting can watch speech content presented and/or a PowerPoint slide of a meeting or a training synchronously via the mobile terminal, which avoids a problem that the people with poor eyesight cannot watch the speech content presented and/or the PowerPoint slide of the meeting or the training clearly, thus improving usability of accessing the virtual desktop and improving user experience.

The internal function modules and the schematic structure of the mobile terminal are described above. FIG. 4 is a block diagram of a mobile terminal according to another example embodiment of the present disclosure. As shown in FIG. 4, the mobile terminal may be realized as including:

a receiver 41, configured to obtain preset address information, in which the address information includes a communication address of a virtual desktop client; and

a memory 42, configured to store instructions executable by a processor 43;

in which, the processor 43 is configured to:

establish a connection with the virtual desktop client according to the communication address of the virtual desktop client, and to receive virtual desktop information sent by the virtual desktop client.

With respect to the devices in the above embodiments, the specific operation modes of individual modules therein have been described in detail in the embodiments regarding the methods, which will not be elaborated herein.

According to the mobile terminal in the embodiments of the preset disclosure, by obtaining the preset address information, establishing a connection with the virtual desktop client according to the communication address of the virtual desktop client and receiving virtual desktop information sent by the virtual desktop client, people attending a meeting may establish a connection with the virtual desktop client via the mobile terminals carried by themselves, such that a quick verification and establishment of accessing the virtual desktop may be achieved. With remote access to the virtual desktop via the mobile terminal, people attending the meeting can watch speech content presented and/or a PowerPoint slide of a meeting or a training synchronously via the mobile terminal, which avoids a problem that the people with poor eyesight cannot watch the speech content presented and/or the PowerPoint slide of the meeting or the training clearly, thus improving usability of accessing the virtual desktop and improving user experience.

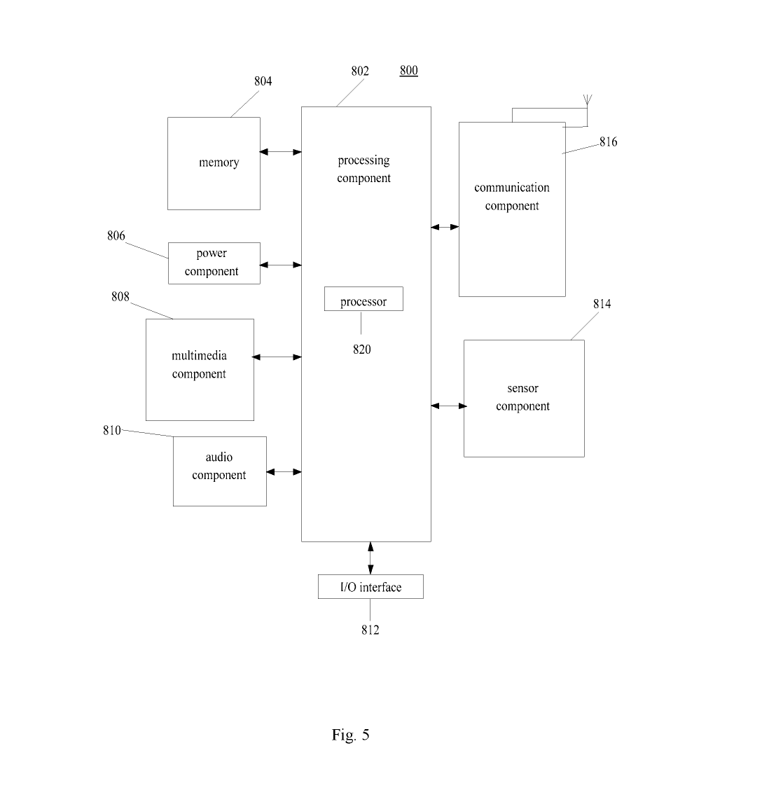

FIG. 5 is a block diagram of a device for accessing a virtual desktop according to an example embodiment of the present disclosure. For example, the device 800 may be a mobile phone, a computer, a digital broadcasting terminal, a messaging device, a game console, a tablet device, a fitness equipment, a Personal Digital Assistant PDA, etc.

As shown in FIG. 5, the device 800 may include the following one or more components: a processing component 802, a memory 804, a power component 806, a multimedia component 808, an audio component 810, an Input/Output (I/O) interface 812, a sensor component 814, and a communication component 816.

The processing component 802 typically controls overall operations of the device 800, such as the operations associated with display, telephone calls, data communications, camera operations, and recording operations. The processing component 802 may include one or more processors 820 to execute instructions to perform all or part of the steps in the above described methods. Moreover, the processing component 802 may include one or more modules which facilitate the interaction between the processing component 802 and other components. For instance, the processing component 802 may include a multimedia module to facilitate the interaction between the multimedia component 808 and the processing component 802.

The memory 804 is configured to store various types of data to support the operation of the device 800. Examples of such data include instructions for any applications or methods operated on the device 800, contact data, phonebook data, messages, pictures, video, etc. The memory 804 may be implemented using any type of volatile or non-volatile memory devices, or a combination thereof, such as a static random access memory (SRAM), an electrically erasable programmable read-only memory (EEPROM), an erasable programmable read-only memory (EPROM), a programmable read-only memory (PROM), a read-only memory (ROM), a magnetic memory, a flash memory, a magnetic or optical disk.

The power component 806 provides power to various components of the device 800. The power component 806 may include a power management system, one or more power sources, and any other components associated with the generation, management, and distribution of power in the device 800.

The multimedia component 808 includes a screen providing an output interface between the terminal 800 and the user. In some embodiments, the screen may include a liquid crystal display (LCD) and a touch panel (TP). If the screen includes the touch panel, the screen may be implemented as a touch screen to receive input signals from the user. The touch panel includes one or more touch sensors to sense touches, swipes, and other gestures on the touch panel. The touch sensors may not only sense a boundary of a touch or swipe action, but also sense a duration time and a pressure associated with the touch or swipe action. In some embodiments, the multimedia component 808 includes a front camera and/or a rear camera. The front camera and the rear camera may receive external multimedia data while the terminal 800 is in an operation mode, such as a photographing mode or a video mode. Each of the front camera and the rear camera may be a fixed optical lens system or have focus and optical zoom capability.

The audio component 810 is configured to output and/or input audio signals. For example, the audio component 810 includes a microphone (MIC) configured to receive an external audio signal when the intelligent terminal 800 is in an operation mode, such as a call mode, a recording mode, and a voice recognition mode. The received audio signal may be further stored in the memory 804 or transmitted via the communication component 816. In some embodiments, the audio component 810 further includes a speaker to output audio signals.

The I/O interface 812 provides an interface for the processing component 802 and peripheral interface modules, such as a keyboard, a click wheel, buttons, and the like. The buttons may include, but are not limited to, a home button, a volume button, a starting button, and a locking button.

The sensor component 814 includes one or more sensors to provide status assessments of various aspects of the terminal 800. For instance, the sensor component 814 may detect an open/closed status of the terminal 800 and relative positioning of components (e.g. the display and the keypad of the terminal 800). The sensor component 814 may also detect a change in position of the terminal 800 or of a component in the terminal 800, a presence or absence of user contact with the terminal 800, an orientation or an acceleration/deceleration of the terminal 800, and a change in temperature of the terminal 800. The sensor component 814 may include a proximity sensor configured to detect the presence of nearby objects without any physical contact. The sensor component 814 may also include a light sensor, such as a CMOS or CCD image sensor, for use in imaging applications. In some embodiments, the sensor component 814 may also include an accelerometer sensor, a gyroscope sensor, a magnetic sensor, a pressure sensor, or a temperature sensor.

The communication component 816 is configured to facilitate wired or wireless communication between the device 800 and other devices. The device 800 can access a wireless network based on a communication standard, such as WIFI, 2G; or 3G; or a combination thereof. In one exemplary embodiment, the communication component 816 receives a broadcast signal or broadcast associated information from an external broadcast management system via a broadcast channel. In one exemplary embodiment, the communication component 816 further includes a near field communication (NFC) module to facilitate short-range communications. For example, the NFC module may be implemented based on a radio frequency identification (RFID) technology, an infrared data association (IrDA) technology, an ultra-wideband (UWB) technology, a Bluetooth (BT) technology, and other technologies.

In exemplary embodiments, the device 800 may be implemented with one or more application specific integrated circuits (ASICs), digital signal processors (DSPs), digital signal processing devices (DSPDs), programmable logic devices (PLDs), field programmable gate arrays (FPGAs), controllers, micro-controllers, microprocessors, or other electronic components, for performing the above described methods.

In exemplary embodiments, there is also provided a non-transitory computer readable storage medium including instructions, such as the memory 804 including instructions. The above instructions are executable by the processor 820 in the device 800, for performing the above-described methods. For example, the non-transitory computer-readable storage medium may be a ROM, a RAM, a CD-ROM, a magnetic tape, a floppy disc, an optical data storage device, and the like.

The present disclosure may include dedicated hardware implementations such as application specific integrated circuits, programmable logic arrays and other hardware devices. The hardware implementations can be constructed to implement one or more of the methods described herein. Applications that may include the apparatus and systems of various examples can broadly include a variety of electronic and computing systems. One or more examples described herein may implement functions using two or more specific interconnected hardware modules or devices with related control and data signals that can be communicated between and through the modules, or as portions of an application-specific integrated circuit. Accordingly, the computing system disclosed may encompass software, firmware, and hardware implementations. The terms “module,” “sub-module,” “unit,” or “sub-unit” may include memory (shared, dedicated, or group) that stores code or instructions that can be executed by one or more processors.

A non-transitory computer readable storage medium, having instructions stored therein that, when executed by processor of a mobile terminal, cause the mobile terminal to perform a method, the method including:

obtaining preset address information by the mobile terminal, in which the address information includes a communication address of a virtual desktop client; and

establishing a connection with the virtual desktop client by the mobile terminal according to the communication address of the virtual desktop client, and receiving virtual desktop information sent by the virtual desktop client.

Obtaining preset address information by the mobile terminal includes:

obtaining preset address information stored in a NFC reader by the mobile terminal through performing NFC communication with the NFC reader; or obtaining preset address information in a barcode or a two-dimensional code by the mobile terminal through scanning the barcode or the two-dimensional code.

The communication address of the virtual desktop client is a MAC address of the virtual desktop client, and establishing a connection with the virtual desktop client by the mobile terminal according to the communication address of the virtual desktop client includes: establishing a connection with the virtual desktop client by the mobile terminal according to the MAC address of the virtual desktop client.

Establishing a connection with the virtual desktop client by the mobile terminal according to the MAC address of the virtual desktop client includes: establishing a connection with the virtual desktop client by the mobile terminal via a wireless network according to the MAC address of the virtual desktop client.

The wireless network includes a Bluetooth or a WIFI.

Other embodiments of the invention will be apparent to those skilled in the art from consideration of the specification and practice of the invention disclosed here. This application is intended to cover any variations, uses, or adaptations of the disclosure following the general principles thereof and including such departures from the present disclosure as come within known or customary practice. It is intended that the specification and examples be considered as exemplary only, with a true scope and spirit of the disclosure being indicated by the following claims.

It will be appreciated that the present invention is not limited to the exact construction that has been described above and illustrated in the accompanying drawings, and that various modifications and changes can be made without departing form the scope thereof. It is intended that the scope of the invention only be limited by the appended claims.

What is claimed is:

1. A method for accessing a virtual desktop, comprising:
obtaining preset address information by a mobile terminal, wherein the address information comprises a communication address of a virtual desktop client; and
establishing a connection between the virtual desktop client and the mobile terminal according to the communication address of the virtual desktop client, and receiving virtual desktop information sent by the virtual desktop client.

2. The method according to claim 1, wherein obtaining the preset address information by the mobile terminal further comprises:
obtaining the preset address information stored in a Near Field Communication (NFC) reader by the mobile terminal through performing NFC with the NFC reader.

3. The method according to claim 1, wherein obtaining the preset address information by the mobile terminal further comprises:
obtaining the preset address information in a barcode or a two-dimensional code by the mobile terminal through scanning the barcode or the two-dimensional code.

4. The method according to claim 1, wherein the communication address of the virtual desktop client is a Media Access Control (MAC) address of the virtual desktop client, and establishing a connection between the virtual desktop client with the mobile terminal according to the communication address of the virtual desktop client further comprises:
establishing the connection between the virtual desktop client and the mobile terminal according to the MAC address of the virtual desktop client.

5. The method according to claim 4, wherein establishing the connection between the virtual desktop client and the mobile terminal according to the MAC address of the virtual desktop client further comprises:
establishing the connection between the virtual desktop client and the mobile terminal via a wireless network according to the MAC address of the virtual desktop client.

6. The method according to claim 5, wherein the wireless network further comprises a Bluetooth or a Wireless Fidelity WIFI.

7. A mobile terminal, comprising:
a processor;
a receiver, configured to obtain preset address information, wherein the address information comprises a communication address of a virtual desktop client; and
a memory, configured to store instructions executable by the processor,
wherein the processor is configured to:
establish a connection between the virtual desktop client and the mobile terminal according to the communication address of the virtual desktop client, and receive virtual desktop information sent by the virtual desktop client.

8. The mobile terminal according to claim 7, wherein the receiver is configured to:
obtain the preset address information stored in a Near Field Communication (NFC) reader by performing NFC with the NFC reader.

9. The mobile terminal according to claim 7, wherein the receiver is configured to:
obtain the preset address information in a barcode or a two-dimensional code by scanning the barcode or the two-dimensional code.

10. The mobile terminal according to claim 7, the communication address of the virtual desktop client obtained by the obtaining module is a Media Access Control (MAC) address of the virtual desktop client; and
the processor is further configured to:
establish the connection between the virtual desktop client and the mobile terminal according to the MAC address of the virtual desktop client.

11. The mobile terminal according to claim 10, wherein, the processor is further configured to:
establish the connection with the virtual desktop client via a wireless network according to the MAC address of the virtual desktop client.

12. The mobile terminal according to claim 11, wherein, the wireless network is a Bluetooth or a Wireless Fidelity WIFI.

13. A non-transitory computer readable storage medium having stored therein instructions that, when executed by one or more processors of a mobile terminal, cause the mobile terminal to perform:
obtaining preset address information by a mobile terminal, wherein the address information comprises a communication address of a virtual desktop client; and
establishing a connection between the virtual desktop client and the mobile terminal according to the communication address of the virtual desktop client, and receiving virtual desktop information sent by the virtual desktop client.
